(19) United States
(12) Patent Application Publication
(10) Pub. No.: US 2003/0140261 A1
(43) Pub. Date: Jul. 24, 2003

(54) Control apparatus

(76) Inventors: Minoru Takasaki, Kanagawa (JP); Hiroki Sue, Kanagawa (JP); Yasuhiro Harada, Kanagawa (JP)

Correspondence Address: ROBIN BLECKER & DALEY, 2ND FLOOR, 330 MADISON AVENUE, NEW YORK, NY, 10017, US

(21) Appl. No.: 10/347,944

(22) Filed: Jan. 20, 2003

(30) Foreign Application Priority Data
Jan. 24, 2002 (JP) 015678/2002
Jan. 24, 2002 (JP) 015621/2002

(51) Int. Cl. G06F 1/26

(52) U.S. Cl. 713/300

(57) ABSTRACT

Disclosed is a control apparatus in which when a voltage falls, a reference voltage is changed depending on the state of a CPU, and whether reset should be executed or not is decided. Alternatively, shift to an endless loop is performed on software of the CPU to create an abnormal state of the CPU, and reset is executed.

### BACKGROUND OF THE INVENTION

1. Field of the Invention

The present invention relates to a control apparatus incorporating a microprocessor or microcomputer to which a power source is supplied from a battery.

2. Related Background Art

In general, in various kinds of control apparatuses using a CPU to which a power source is supplied by boosting a battery voltage, execution of its software cannot be secured if the source voltage of the CPU drops below a minimum operating voltage above which the operation is secured. Therefore, a source voltage checking unit for checking the source voltage is provided, and a method to reset the CPU when the source voltage falls down to the minimum operating voltage, and stop the operation of the control apparatus is used.

It is, however, necessary to set a voltage, with which the checking unit judges, in conformity with the maximum operation-securing voltage among various circuits in the system. On the other hand, it is desirable for an apparatus using a battery as a power source to be capable of operating at as low a voltage as possible from the viewpoint of lifetime of the battery.

Further, there is another problem in the power source battery that the battery voltage may temporarily fluctuate. Accordingly, it is necessary to boost the battery voltage of a power source for a microcomputer, and use a voltage obtained by stabilizing the boosted voltage. Even when the battery voltage is boosted, however, there is a possibility that operation of the microcomputer becomes unstable and fails in cases where the boosted voltage is not sufficiently high, where the battery voltage cannot be fully boosted for some reasons and falls during the operation of the microcomputer, and others.

### SUMMARY OF THE INVENTION

The present invention is found out to deal with such situation.

For dealing with above situation, it is an object of the present invention to provide a control apparatus in which an optimum operation-securing voltage is set according to operating conditions of a control unit, and the control apparatus is designed to reset when a power source voltage goes below the operation-securing voltage.

It is another object of the present invention to provide a control apparatus in which when a power source voltage goes below a predetermined value, an abnormal condition is intentionally created on its software to reset a CPU.

For achieving the above object, one aspect of the present invention is a control apparatus including a CPU, in which the level of a supply power supplied to a CPU is judged, and the CPU is reset when the supply power level goes below a predetermined value, and which prepares a plurality of predetermined values in accordance with operation conditions or states of the CPU. The operation state can be defined by discrimination between normal driving state and low-rate driving state, or between peripheral circuits the CPU accesses.

Another aspect of the present invention is a control apparatus in which when the level of a supply power supplied to a CPU goes below a predetermined value, the operation state of the CPU is changed to an abnormal state by executing an endless loop process on its software, the abnormal state of the CPU is detected by operation of a watchdog timer for detecting the abnormal state, and the like, and a system of the CPU is reset.

These and further aspects and features of the invention will become apparent from the following detailed description of preferred embodiments thereof in conjunction with the accompanying drawings.

### BRIEF DESCRIPTION OF THE DRAWINGS

FIG. 1 is a view illustrating the circuit structure of a main portion of a first embodiment according to the present invention;

FIG. 2 is a view illustrating the circuit structure of a main portion of a second embodiment according to the present invention;

FIG. 3 is a view illustrating the circuit structure of a main portion of a third embodiment according to the present invention;

FIG. 4 is a view illustrating the circuit structure of a main portion of a fourth embodiment according to the present invention;

FIG. 5 is a view illustrating the circuit structure of a main portion of a fifth embodiment according to the present invention;

FIG. 6 is a view illustrating the structure of a voltage detecting circuit in the fifth embodiment according to the present invention;

FIG. 7 is a graph showing a drop of the voltage in the fifth embodiment according to the present invention;

FIG. 8 is a timing chart in the fifth embodiment according to the present invention; and

FIG. 9 is a flow chart in the fifth embodiment according to the present invention.

### DESCRIPTION OF THE PREFERRED EMBODIMENTS

Embodiments of the present invention will be described in detail hereinafter referring to the drawings.

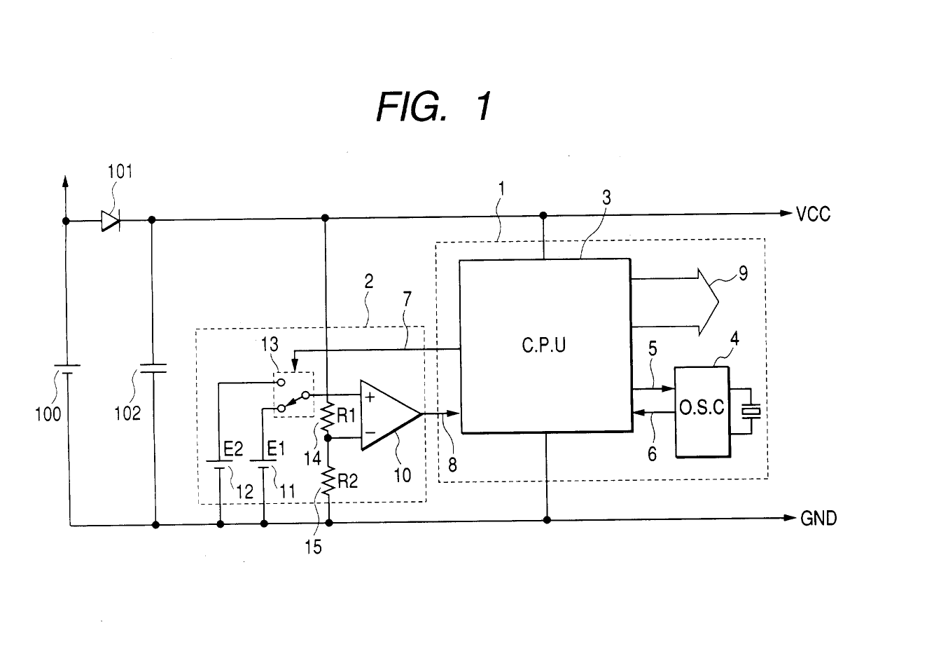

FIG. 1 is a view illustrating a portion of a circuit of a control apparatus provided with a power source voltage checking circuit for checking the voltage of a power source of a first embodiment according to the present invention. In FIG. 1, there are shown a circuit 1 of the control apparatus, and the power source voltage checking circuit 2. Reference numeral 3 designates a central processing unit (also referred to as a CPU in this specification) for controlling the operation of the control apparatus, which is ordinarily a microprocessor. Reference numeral 4 designates an oscillating circuit for generating a clock signal for the CPU 3, which is capable of supplying outputs of two kinds of oscillation frequencies, here 32 KHz and 4 MHz. Reference numeral 5 designates a signal line for supplying from the CPU 3 a signal for changing a frequency. When the CPU 3 outputs “Hi” to the oscillating circuit 4 through the signal line 5, the oscillating circuit 4 outputs a 4-MHz clock into a clock line 6. When the CPU 3 outputs “Lo”, the oscillating circuit 4 outputs a 32-KHz clock into the clock line 6. The CPU 3 proceeds to processing its software in synchronization with the clock. In general, when high-rate processing is required for a control apparatus, the control apparatus operates with a high-rate clock of 4 MHz. When reduction of the amount of consumed power is required, the control apparatus operates with a low-rate clock. At the time of operation with the low-rate clock, a lower limit of an operation-securing voltage is set low. This lower limit voltage is indicated by Emin1 in this embodiment. At the time of operation with the high-rate clock, a lower limit of the operation-securing voltage increases. This lower limit voltage is indicated by Emin2 in this embodiment. Naturally, Emin1<Emin2. Reference numeral 7 designates a control signal line through which the CPU 3 supplying to the checking unit 2 a control signal for switching a reference level for judging a source voltage. Reference numeral 8 designates a reset signal line. When the source voltage checking unit 2 outputs “Hi” into the reset signal line 8, the CPU 3 is reset such that operation of the control apparatus is stopped to return to its initial condition. Reference numeral 9 designates a signal line connected to peripheral circuits (not shown). The peripheral circuits include a memory circuit, such as a mask ROM, a RAM and an EEPROM, in which software for controlling the CPU 3 is written, driver circuits for driving various actuators, and so forth.

Reference numeral 10 designates a comparator which compares a voltage of a reference voltage source 11 or 12 with a voltage created by dividing a voltage between electric source VCC and GND by resistors 14 and 15. When the divided voltage goes below the reference voltage, the comparator 10 outputs “Hi”. When the divided voltage is higher than the reference voltage, the comparator 10 outputs “Lo”. Reference numeral 13 designates a switch for switching the reference voltage source connected to the comparator 10 in response to the signal output into the signal line 7 from the CPU 3. The Reference voltage source 11 is a voltage source that is selected when the CPU 3 operates with the low-rate clock. Its output voltage is E1. The resistors 14 and 15 are voltage-dividing resistors for determining a voltage connected to one input terminal of the comparator 10, respectively. Their resistance values are R1 and R2, respectively.

Further, reference numeral 100 designates a removable battery used as an electric source. A voltage supplied to the control circuit system from the battery 100 is indicated by VCC. The battery 100 also can supply a large current to actuators (not shown), and the like. Reference numerals 101 and 102 designate a diode, and a capacitor with a large capacitance, respectively, and those two components back up the power source of the control system. For example, if a certain actuator (not shown) is driven to cause a large current flow from the battery 100, a voltage between opposite terminals of the battery tends to abruptly fall. In such a case, however, the diode 101 prevents a current flow from the control system toward the battery 100, and a charge stored in the capacitor 102 is gradually discharged such that the abrupt fall of the VCC is prevented.

When the voltage source 11 is selected, a value of the VCC, at which the comparator 10 is inverted, is defined by (1+R1/R2)×E1, and the comparator 10 outputs “Hi” if the VCC goes below this voltage. Accordingly, R1, R2 and E1 are determined such that the following equation (1) can be established.

Emin1=(1+R1/R2)×E1 (1)

The voltage source 12 is a voltage source which is chosen when the CPU 3 operates with the high-rate clock. Its output voltage is E2. When the voltage source 12 is selected, a value of the VCC, at which the comparator 10 is inverted, is defined by (1+R1/R2)×E2, and the comparator 10 outputs “Hi” if the VCC goes below this voltage. Accordingly, E2 is determined such that the following equation (2) can be established.

Emin2=(1+R1/R2)×E2 (2)

Operation of the above-discussed control circuit will be described hereinafter.

Normally, since the CPU 3 operates with the low-rate clock, “Lo” is output into the signal line 5 and the oscillating circuit 4 outputs signal with 32 KHz. Further, the reference voltage of the comparator 10 is connected to E1 by the signal line 7. In such a state, current requirement of the CPU 3 is small, and at the same time the CPU 3 never be reset so far as the VCC does not largely drops (below E1). The backup by the capacitor 102 is hence effective for a long time. Therefore, even when the control circuit is in operation, battery exchange and the like are possible if only a short period is needed.

On the other hand, if the control circuit requires the high-rate operation, the output to the signal line 7 is initially changed to switch the reference voltage of the comparator 10 to E2. After that, the output to the signal line 5 is switched to change over the output of oscillator 4 to 4 MHz. When operation in this state continues and no high-rate operation is then needed, the frequency of the oscillator 4 is turned back to 32 KHz and the reference voltage of the comparator 10 is then changed to E1 by controlling the switch 13 through the signal line 7. If an actuator (not shown) is brought into operation during the high-rate operation of the control circuit under a condition that power consumption of the battery advances and the amount of its remnant decreases, there is a possibility that the VCC drops below the operation-securing range of the CPU 3. In such a case, since the reference voltage of the comparator 10 is set at E2, the output of the comparator 10 is inverted from “Lo” to “Hi” to reset the CPU 3. Control can be hence terminated such that the system does not run out of control.

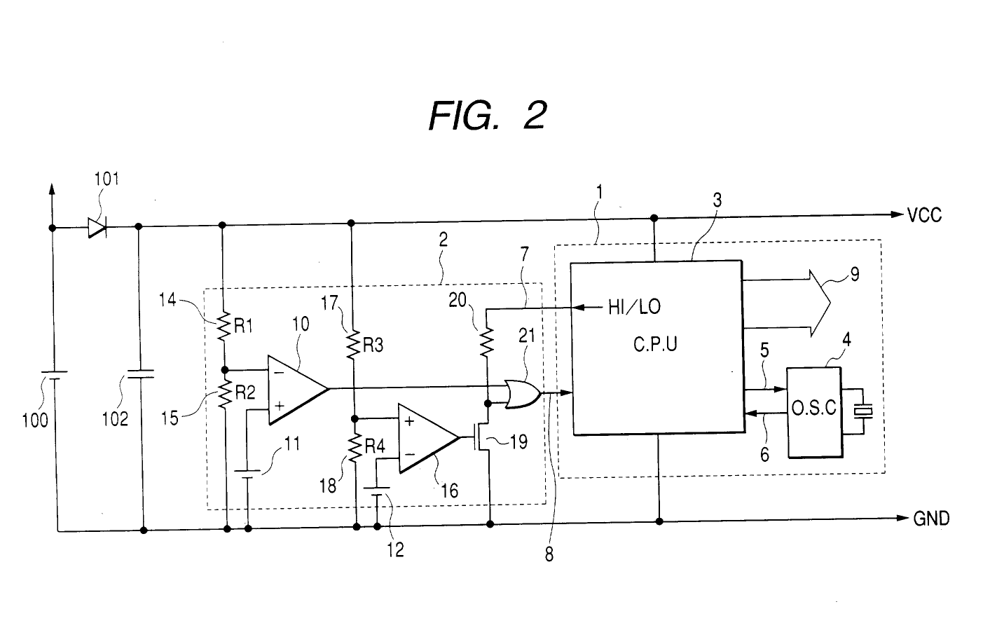

FIG. 2 is a view illustrating a second embodiment of the present invention. Portions different from the first embodiment will be described. Reference numeral 7 designates a control signal line from the CPU 3 to the source voltage checking unit 2. When the control signal is set at “Hi” level, all functions of the source voltage checking unit are activated. In contrast thereto, when the control signal is set at “Lo” level, part of the functions of the source voltage checking unit is made inactive. Its detail is described later.

Reference numerals 10, 11, 14 and 15 designate a circuit for detecting a minimum operation voltage during an operation period of the CPU 3 with its low-rate clock. When the VCC falls below the minimum operation voltage, the comparator 10 outputs “Hi” level. This signal is connected to one input terminal of an OR gate circuit 21. Reference numerals 12, 16, 17 and 18 designate a circuit for detecting a minimum operation voltage during an operation period of the CPU 3 with its high-rate clock. When the VCC falls below this minimum operation voltage, the comparator 16 outputs “Lo” level to set an N-channel FET 19 in its OFF state. When the VCC is higher than the minimum operation voltage of the high-rate clock operation, the FET 19 is set in its ON state. Reference numeral 20 designates a resistor one end of which is connected to a drain of the FET 19 and the other end of which is connected to the signal line 7. The OR gate circuit 21 has two input terminals, and its output terminal is connected to a reset terminal of the CPU 3 through the signal line 8. The other portions have substantially the same functions as the first embodiment.

In the above-discussed circuit, the control apparatus operates in the following manner.

Normally, the CPU 3 sets the output frequency of the oscillator 4 at a low rate, i.e., 32 KHz as in the first embodiment, and outputs “Lo” into the signal line 7. One input terminal of the OR gate circuit 2 is then maintained at “Lo” level in whichever state, i.e., ON state or OFF state, the FET 19 may be. That is, output of the signal from the comparator 16 is forbidden, and the comparator is thus inactivated. The comparator 16 is an element for detecting the minimum operation voltage during the high-rate clock period, but the signal output from the circuit for detecting the minimum operation voltage at the high-rate clock time can be prevented during the operation with the low-rate clock by the above-discussed processing.

When the CPU 3 operates with the high-rate clock, the “Hi” level is output into the signal line 7 and the signal line 5 is then switched to set the output frequency of the oscillator 4 at a high rate, i.e., 4 MHz as in the first embodiment. If power consumption of the battery 100 advances and the VCC drops below the minimum operation voltage during the operation with the high-rate clock, the comparator 16 is inverted to “Lo”. Since the operation-securing voltage at the time of the low-rate clock is lower than that at the time of the high-rate clock, the output of the comparator 10 is maintained at “Lo”. The FET 20 is switched to its OFF state since its gate is turned to “Lo”. On the other hand, since the signal line 7 on one side of the resistor 20 is set at “Hi” level, the drain of the FET 19 is turned to “Hi” level. Accordingly, one side of the OR gate circuit 21 is changed to “Hi” level, so that the signal line 8 is also changed to “Hi” level to reset the CPU 3.

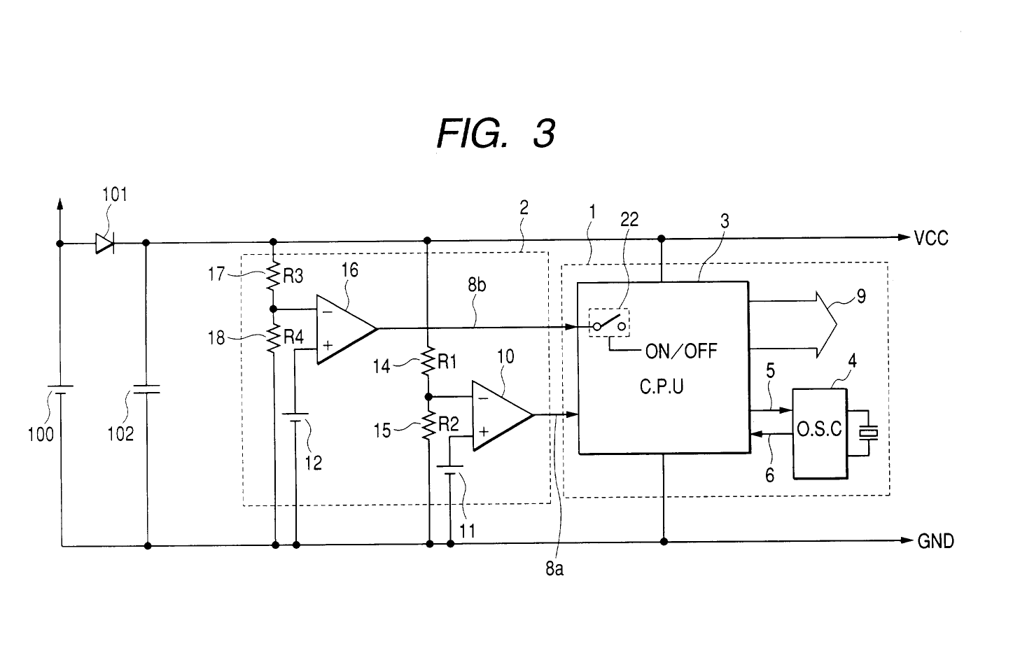

FIG. 3 is a view illustrating a third embodiment of the present invention. In FIG. 3, the comparator 10 is an element for detecting the minimum operation voltage at the time of operation with the low-rate clock, and the comparator 16 is an element for detecting the minimum operation voltage at the time of operation with the high-rate clock. Reference numeral 22 designates a switch in the CPU 3 that can be freely changed over between ON state and OFF state on software.

During operation with the low-rate clock, the CPU 3 sets the internal switch 22 in OFF state. Thereby, a signal in a signal line 8b, which is an output from the power source checking unit 2, is ignored, and no response is made even if the VCC drops below the minimum operation voltage at the time of operation with the high-rate clock. On the other hand, a signal of the comparator 10 for detecting the minimum operation voltage at the time of operation with the low-rate clock is output into a signal line 8a. This signal is not ignored, and is necessarily received. Accordingly, even during operation with the low-rate clock, the CPU 3 is reset if the output of the comparator 10 is inverted to “Hi”.

When operation is to be changed over to the operation with the high-rate clock, the internal switch 22 is initially changed to ON state to establish a condition under which the signal of the comparator 16 can be received. Then, the signal line 5 is changed over to switch the output frequency of the oscillator 4 to the high rate. Therefore, if the VCC falls below the minimum operation voltage at the time of operation with the high-rate clock, the CPU 3 is reset.

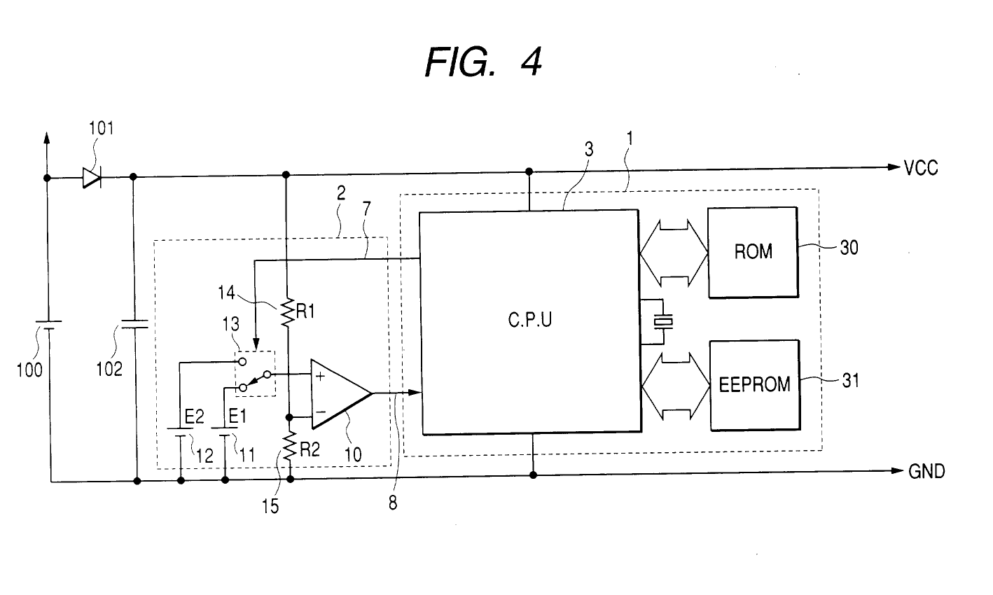

FIG. 4 is a view illustrating a fourth embodiment of the present invention. The control circuit 1 includes two memory circuits in each of which program is written. Reference numeral 30 designates a mask ROM in which software data written at the fabrication time of a chip are recorded. The mask ROM 30 stably operates in a wide voltage range due to its circuit construction, and its data can be read therefrom even at a relatively low source voltage. When data in the mask ROM are used, the minimum operation voltage of the control apparatus 1 is indicated by VCCrom. Reference numeral 31 designates an EEPROM which is a rewritable nonvolatile memory. In the EEPROM, software optimized according to an object to be controlled by the control circuit 1, software for revising the program in the mask ROM, and the like can be written. The control object can be thereby controlled more flexibly. The operation voltage range of the EEPROM is limited, and therefore, the source voltage must be severely regulated. When data in the EEPROM is used, the minimum operation voltage of the control circuit 1 is indicated by VCCeep. Naturally, VCCrom<VCCeep.

The control circuit 2 has the same structure as that of the first embodiment. The reference voltage source 11 is an element for detecting the VCCrom, and its voltage E1 is set as follows.

E1=VCCrom×(R2/(R1+R2))

Similarly, the reference voltage source 12 is an element for detecting the VCCeep, and its voltage E2 is set as follows.

E2=VCCeep×(R2/(R1+R2))

Operation of the above-discussed control circuit will be described hereinafter.

Normally, the CPU 3 begins to be operated by software data written in the mask ROM 30. The reference voltage source 11 is connected to the input terminal of the comparator 10 through the switch 13. When the memory circuit is to be switched to the EEPROM 31, the CPU 3 initially controls the signal line 7 to change over the switch 13. The reference voltage source 12 is thus connected to the input terminal of the comparator 10. Further, when the memory circuit is to be returned from the EEPROM 31 back to the mask ROM 30, the CPU 3 controls the switch 13 to change the input terminal of the comparator 10 from the reference voltage source 12 to the reference voltage source 11, after switching to the mask ROM 30 is performed. Since the CPU 3 operates in such a manner, the comparator 10 always compares the source voltage with the VCCeep when the EEPROM 31 is accessed. Hence, if the VCC drops below the VCCeep, the comparator 10 serves to reset the CPU 3. Accordingly, the EEPROM can be prevented from outputting erroneous data even when the source voltage falls.

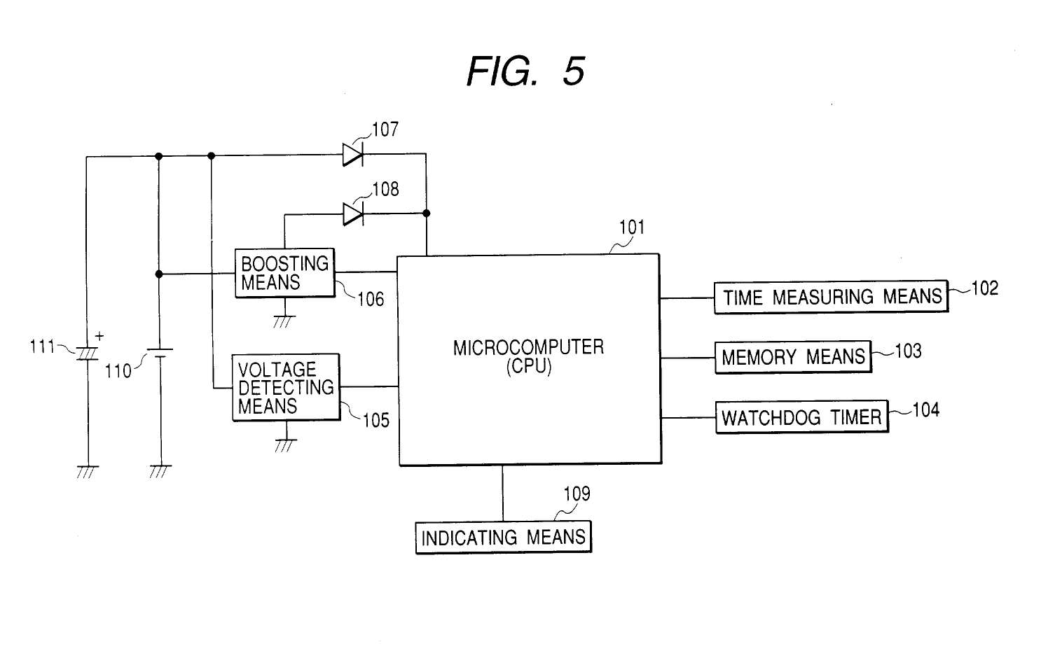

FIG. 5 is a view illustrating the circuit construction of a fifth embodiment of the present invention. In FIG. 5, there are shown a control microcomputer 101 for performing operation and sequence control, a timer or time measuring unit 102 for measuring time, a nonvolatile memory 103, such as an EEPROM, which is a memory mean, and a watchdog timer 104 for detecting operational abnormality of the microcomputer and the like by time checking. The watchdog timer 104 is designed to be reset by the reset signal that is output from the microcomputer with generation intervals set by program, when the CPU is in normal operation. The watchdog timer 104 is further designed to output an abnormality detecting signal after time is up, unless a next reset signal is output from the microcomputer by finishing time of a time-limited operation which begins after the reset of the watchdog timer. The watchdog timer considers the operation of the microcomputer to be normal while no abnormality detecting signal is output. Further, when abnormality, such as runaway of the microcomputer, occurs, abnormality of the microcomputer is informed by the output of the abnormality detecting signal since no reset signal is generated by program.

There are also arranged a voltage detecting unit 105 for detecting the battery voltage, a boosting unit 106 for boosting the battery voltage, a diode 107 for the power source, a diode 108 for supplying a power source from the boosting unit 106, a display or indicating unit 109, a battery 110 which is the power source, and a capacitor 111 for backing up the power source.

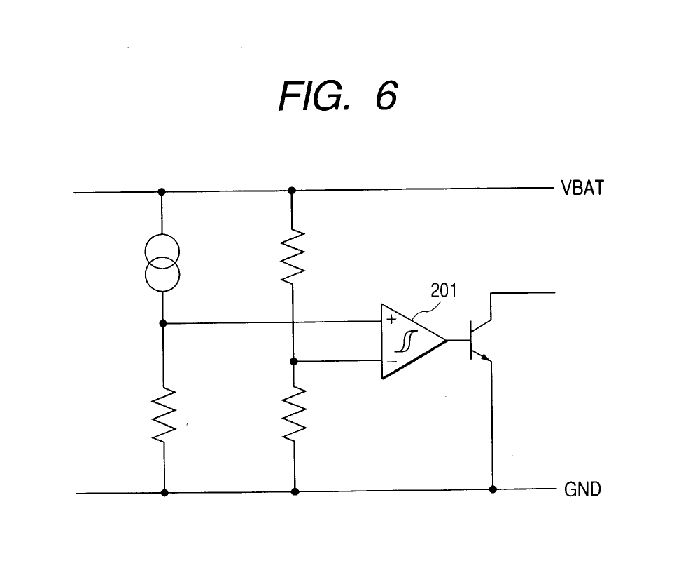

FIG. 6 illustrates a circuit for detecting the battery voltage (VBAT), which includes a conventional comparator 201, a portion for generating a constant current source, a bleeder resistor for detecting the VBAT, and others. The output of the comparator 201 is inverted when the battery voltage (VBAT) drops below a preset threshold level.

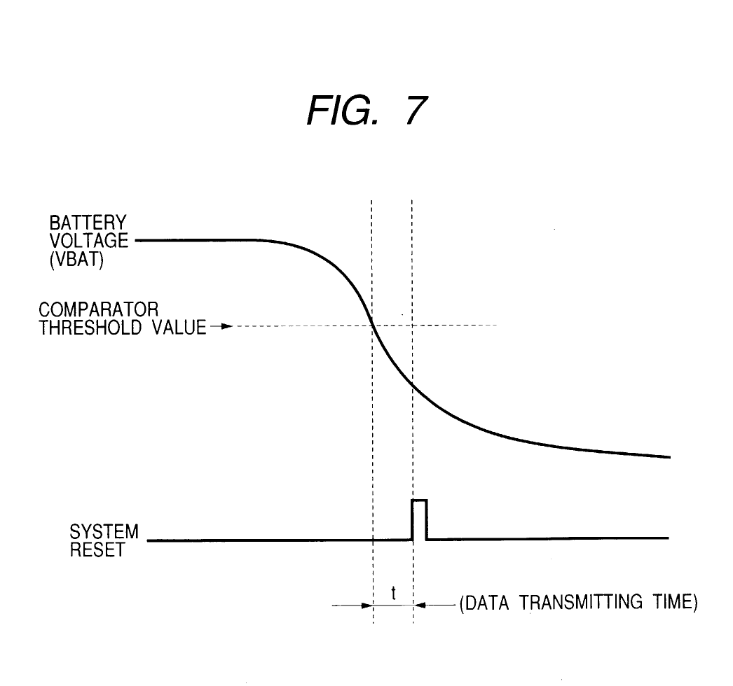

FIG. 7 is a graphic representation illustrating a drop of the battery voltage (VBAT) due to charge of a stroboscope, and the like. In the graph, the comparator 201 generates the detection signal when the battery voltage is detected and found to be below a preset threshold, when the battery voltage falls below the threshold, the timer is started and the system reset is executed after a predetermined time (t) elapses, and data in the volatile memory and the like are transferred to the nonvolatile memory during the predetermined time (t) between the start of the timer and the execution of the system reset. Further, after the data is transferred to the nonvolatile memory, the output of the comparator 201 is confirmed until the predetermined time (t) has elapsed. If it is confirmed that the battery voltage (VBAT) has been recovered, the timer operation is stopped and returned to the initial state, and then the microcomputer return to the execution state of an original program. Hence, if the battery voltage drops below the comparator threshold, the system reset is executed after a delay time of the predetermined time (t) and in only a case that the battery voltage has not been recovered in the predetermined time (t). Therefore, no system reset is executed due to instantaneous break of the battery voltage such as chattering of the battery piece, and hence, erasure of data in the volatile memory and the like can be avoided. For example, it can be prevented to erase data of the date and return to the initial condition without knowing it.

Following is the detail of the embodiment for obtaining the same effect as that of the above described embodiment, without the exclusive time measurement means 102. In this embodiment, the watchdog timer which is usually provided within a system using a microcomputer.

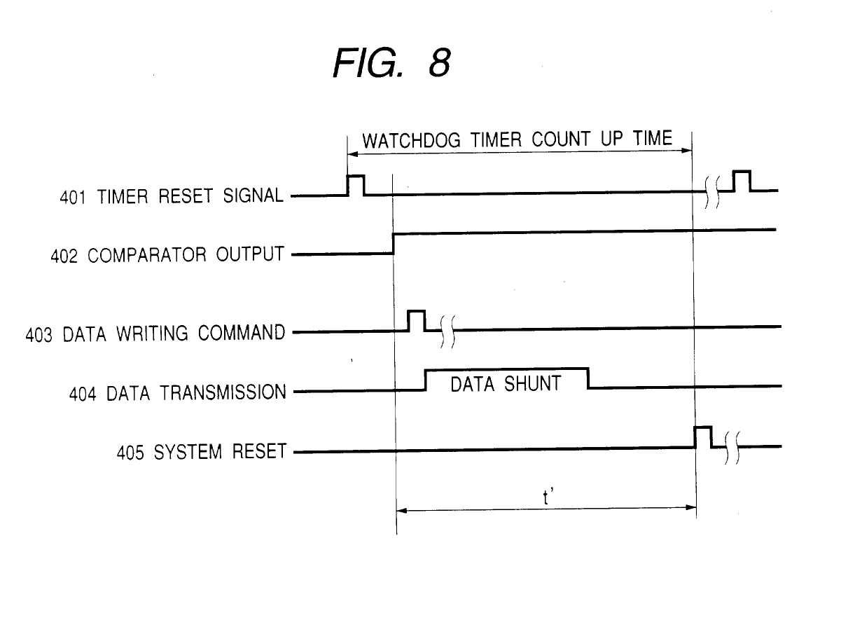

FIG. 8 is a timing chart representing the relationship between the watchdog timer and the system reset.

A timer reset signal 401 is a signal for canceling the watchdog timer. A comparator output 402 is inverted depending on if the battery voltage is higher or lower than the comparator threshold shown in FIG. 7. A data writing command 403 is a signal output from the CPU when the battery voltage falls below the comparator threshold. Data transmission 404 is for shunting various data within the nonvolatile memory after the data writing command 403. System reset 405 is for executing reset after the time period (t′) elapses from the inversion of the comparator output 402.

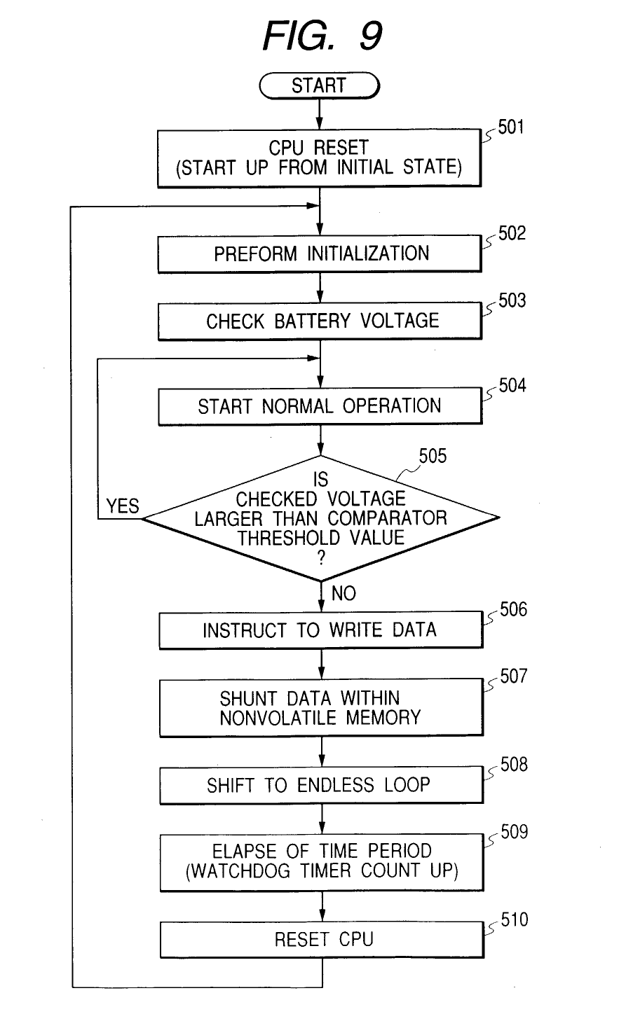

FIG. 9 is a flow chart showing sequential operations from start to return in this embodiment. When the power source of the microcomputer is activated to execute the CPU system reset, the CPU 101 is started up from the initial condition (501). Initially, program of initialization is executed (502), check of the battery voltage is performed (503), and normal operation is started to sequentially execute the program (504). Then, if the battery voltage is larger than the comparator threshold during the normal operation, the normal operation is repeated. If the battery voltage is smaller than the comparator threshold, operation proceeds to a next sequence (505). In the case where the battery voltage goes below the comparator threshold, the CPU instructs to write data (506), and various data are shunted within the nonvolatile memory (507). After that, software is further shifted to an endless loop (508). And, if a time period elapses without canceling the watchdog timer (the endless loop is an abnormal operation, and no reset signal is output for the timer) (509), the CPU is forcedly reset (510) and returns to the initial condition (502) Thus, return to the initial condition is performed by software.

In the initialization (502), data of the nonvolatile memory is read to return the system to its original condition and perform the rest of process.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A control apparatus comprising:
a processing circuit; and
a control circuit for judging a level of a power source, which supplies power to said processing circuit, based on a plurality of reference levels set according to operation states of said processing circuit, and changing the operation state of said processing circuit.

2. A control apparatus according to claim 1, wherein said processing circuit includes a CPU.

3. A control apparatus according to claim 1, wherein the judgement of the power supply level is performed based on a result of detection of a power source voltage or a voltage supplied to said processing circuit.

4. A control apparatus according to claim 1, wherein the operation state of said processing circuit is a normal operation state, or a low-rate driving state.

5. A control apparatus according to claim 4, wherein the reference level set according to the normal operation state of said processing circuit is higher than the reference level set according to the low-rate driving state of said processing circuit.

6. A control apparatus according to claim 1, wherein said control circuit changes the operation state of said processing circuit by a reset signal.

7. A control apparatus according to claim 1, wherein the operation state of said processing circuit is changed depending on a load circuit said processing circuit accesses.

8. A control apparatus according to claim 7, wherein said load circuit includes at least a mask ROM and an EEPROM.

9. A control apparatus according to claim 8, wherein the reference level at the time when said processing circuit accesses said mask ROM is lower than the reference level at the time when said processing circuit accesses said EEPROM.

10. A control apparatus according to claim 7, wherein said control circuit changes the operation state of said processing circuit by a reset signal.

11. A control apparatus comprising:
a control circuit for judging a level of power supplied from a power source or a level of power supplied to a processing circuit, and changing an operation state of said processing circuit to an abnormal state when the power supply level reaches a predetermined level; and
a checking circuit for detecting the abnormal state, and changing the operation state of said processing circuit to another operation state.

12. A control apparatus according to claim 11, wherein said processing circuit includes a CPU.

13. A control apparatus according to claim 11, wherein the judgement of the power supply level is performed by judging a voltage supplied to said processing circuit.

14. A control apparatus according to claim 11, wherein the abnormal state is an endless loop processing state.

15. A control apparatus according to claim 11, wherein said checking circuit changes the operation state of said processing circuit to another operation state by a reset signal.

16. A control apparatus according to claim 11, wherein said processing circuit is designed to output a signal at a predetermined time interval in a normal operation time, and said checking circuit judges the operation state abnormal when the signal is not output within a predetermined definite time period.

17. A control apparatus according to claim 16, wherein said checking circuit includes a watchdog timer for repeating time measuring operations each time the signal is detected, and said checking circuit judges the operation state of said processing circuit abnormal when the time measuring operation by said watchdog timer continues beyond a predetermined time period.

18. A control apparatus according to claim 17, wherein predetermined data are transferred to a nonvolatile memory after a drop of the power supply level below the predetermined level is detected and before said control circuit changes the operation state of said processing circuit to the abnormal state.

19. A control apparatus according to claim 18, wherein before said control circuit changes the operation state of said processing circuit to the abnormal state, said level of power supplied to said processing circuit is compared with the predetermined level, and then, if said level of power supplied to said processing circuit is higher than the predetermined level, the change of the operation to the abnormal state is stopped and said control circuit continues an original process, and if said level of power supplied to said processing circuit is lower than the predetermined level, the change of the operation state to the abnormal state is executed.
